(19) United States
(12) Patent Application Publication
(10) Pub. No.: US 2024/0256860 A1
(43) Pub. Date: Aug. 1, 2024

(54) FINETUNING FOR MULTI-TASK LEARNING

(71) Applicant: Mobileye Vision Technologies Ltd., Jerusalem (IL)

(72) Inventors: Shai Shalev-Shwartz, Jerusalem (IL); Eran Malach, Jerusalem (IL); Gal Kaplun, Jerusalem (IL); Andrey Gurevich, Jerusalem (IL); Mazor David, Tel-Aviv (IL); Tal Swisa, Tel-Aviv (IL)

(21) Appl. No.: 18/424,024

(22) Filed: Jan. 26, 2024

Related U.S. Application Data
(60) Provisional application No. 63/481,654, filed on Jan. 26, 2023.

(51) Int. Cl. G06N 3/08

(52) U.S. Cl. CPC G06N 3/08

(57) ABSTRACT

Systems and methods generate an extended trained model. In one implementation, a method includes obtaining a preexisting trained model, the preexisting trained model including a plurality of preexisting weights, wherein each of the plurality of preexisting weights is associated with a preexisting value; identifying a subset of the plurality of preexisting weights; generating a plurality of extended weights based on a training process using duplicates of the subset of the plurality of preexisting weights; and generating the extended trained model, wherein the extended trained model includes the plurality of preexisting weights and the plurality of extended weights.

### CROSS REFERENCE TO RELATED APPLICATION

This application claims the benefit of priority of U.S. Provisional Application No. 63/481,654, filed Jan. 26, 2023. The foregoing application is incorporated herein by reference in its entirety.

### BACKGROUND

### Technical Field

The present disclosure relates generally to training artificial intelligence models and, more specifically, to systems and methods for generating an extended model through parameter-efficient finetuning.

### Background Information

As technology continues to advance, the goal of a fully autonomous vehicle that is capable of navigating on roadways is on the horizon. Autonomous vehicles may need to take into account a variety of factors and make appropriate decisions based on those factors to safely and accurately reach an intended destination. For example, an autonomous vehicle may need to process and interpret visual information (e.g., information captured from a camera) and may also use information obtained from other sources (e.g., from a GPS device, a speed sensor, an accelerometer, a suspension sensor, etc.). In some cases, autonomous vehicles may rely heavily on artificial intelligence models for analyzing image data or performing various other tasks, which may require multiple models for performing different tasks. Training each of these models, however, often requires large sets of training data, each of which may require labels for training the model to perform a specific task. This training can thus place a tremendous demand for resources, including data storage, processing, and transmission bandwidth.

In recent years, it has become increasingly popular to finetune large pretrained models trained for one task to generate a model for performing another task. As the popularity of finetuning these models grows, so does the importance of deploying them efficiently for solving new downstream tasks. Thus, there has been a growing interest, especially in the natural language processing (NLP) domain, in Parameter-Efficient Transfer-Learning (PETL) where either a small number of parameters are modified, a few small layers are added or most of the network is masked. Using only a fraction of the parameters for each task can help in avoiding catastrophic forgetting and can be an effective solution for both multi-task learning and continual learning. These methods encompass Prompt Tuning, adapters, Low-Rank Adaptation (LoRA), sidetuning, feature selection, and masking.

In a recent study, selective layer finetuning on small datasets was found to be more effective than traditional finetuning. See Lee et al., Surgical Fine-Tuning Improves Adaptation to Distribution Shifts, 2022. The study observed that the training of different layers yielded varied results, depending on the shifts in data distributions. Specifically, the study found that when there was a label shift between the source and target data, later layers performed better, but in cases of image corruption, early layers were more effective.

However, this study did not provide techniques for strategically selecting layers for generating an extended trained model. Accordingly, techniques are required for leveraging the interaction between the appropriate layers to finetune. Further, techniques are needed to identify which layers to finetune based on the type of corruption through strategic layer selection. Techniques are also needed for advantageously optimizing for inference time efficiency in the Multi-Task Learning (MTL) setting.

### SUMMARY

Embodiments consistent with the present disclosure provide systems and methods, and non-transitory computer-readable media.

In an embodiment, a method for generating an extended trained model may include obtaining a preexisting trained model, the preexisting trained model including a plurality of preexisting weights, wherein each of the plurality of preexisting weights is associated with a preexisting value; identifying a subset of the plurality of preexisting weights; generating a plurality of extended weights based on a training process using duplicates of the subset of the plurality of preexisting weights; and generating the extended trained model, wherein the extended trained model includes the plurality of preexisting weights and the plurality of extended weights.

In an embodiment, a system for generating an extended trained model may include at least one processor comprising circuitry and a memory. The at least one processor may be programmed to obtain a preexisting trained model, the preexisting trained model including a plurality of preexisting weights, wherein each of the plurality of preexisting weights is associated with a preexisting value; identify a subset of the plurality of preexisting weights; generate a plurality of extended weights based on a training process using duplicates of the subset of the plurality of preexisting weights; and generate the extended trained model, wherein the extended trained model includes the plurality of preexisting weights and the plurality of extended weights.

Consistent with other disclosed embodiments, non-transitory computer readable storage media may store program instructions, which are executed by at least one processor and perform any of the methods described herein.

The foregoing general description and the following detailed description are exemplary and explanatory only and are not restrictive of the claims.

### BRIEF DESCRIPTION OF THE DRAWINGS

The accompanying drawings, which are incorporated in and constitute a part of this disclosure, illustrate various disclosed embodiments. In the drawings:

FIG. 1 is a diagrammatic illustration of an example system for implementing the disclosed embodiments.

FIG. 2A is a block diagram representation of vehicle, consistent with the disclosed embodiments.

FIG. 2B is a block diagram representation of a server, consistent with the disclosed embodiments.

FIG. 3 illustrates an example image that may be processed using a trained system, consistent with the disclosed embodiments.

FIG. 4 illustrates an example technique for selective finetuning of a model, consistent with the disclosed embodiments.

FIGS. 5A, 5B, 5C, and 5D illustrate example experimental results achieved through the disclosed SubTuning techniques, consistent with the disclosed embodiments.

FIG. 6 is an illustration of an example application of SubTuning for multi-task learning, consistent with the disclosed embodiments.

FIG. 7 illustrates an example Siamese SubTuning technique in comparison to other SubTuning techniques, consistent with the disclosed embodiments.

FIG. 8 is a flowchart showing an example process for generating an extended trained model, consistent with the disclosed embodiments.

### DETAILED DESCRIPTION

The following detailed description refers to the accompanying drawings. Wherever possible, the same reference numbers are used in the drawings and the following description to refer to the same or similar parts. While several illustrative embodiments are described herein, modifications, adaptations and other implementations are possible. For example, substitutions, additions or modifications may be made to the components illustrated in the drawings, and the illustrative methods described herein may be modified by substituting, reordering, removing, or adding steps to the disclosed methods. Accordingly, the following detailed description is not limited to the disclosed embodiments and examples. Instead, the proper scope is defined by the appended claims.

Finetuning a pretrained model is one approach for training neural networks on novel tasks, leading to rapid convergence and enhanced performance. The techniques disclosed herein provide a further improved, parameter-efficient finetuning method, involving selectively training a carefully chosen subset of layers while keeping the remaining weights frozen at their initial (pre-trained) values. The disclosed techniques demonstrate that not all layers are created equal: different layers across the network contribute variably to the overall performance, and the optimal choice of layers is contingent upon the downstream task and the underlying data distribution. The disclosed techniques, referred to herein as subset finetuning (or “SubTuning”), offer several advantages over conventional finetuning. The disclosed SubTuning techniques outperform both finetuning and linear probing, especially in scenarios with scarce or corrupted data, achieving state-of-the-art results compared to competing methods for finetuning on small datasets. Further, when data is abundant, SubTuning often attains performance comparable to finetuning while simultaneously enabling efficient inference in a multi-task setting when deployed alongside other models. The various examples discussed herein showcase the efficacy of SubTuning across various tasks, diverse network architectures and pre-training methods.

The techniques disclosed herein include selectively fine tuning specific layers based upon a “finetuning profile.” The finetuning profile serves as a crucial tool to illuminate the significance of different layers during finetuning. This alternative fine tuning method functions to train a carefully chosen subset of layers, keeping the rest of the weights frozen at their initial (pretrained) values. This is in contrast with conventional training techniques in which all the weights of the network are subjected to the tuning process.

The present disclosure illustrates that Sub-Tuning often achieves accuracy comparable to full finetuning of the model, and even surpasses the performance of full finetuning when training data is scarce. Therefore, Sub-Tuning allows for the deployment of new tasks at minimal (or at least reduced) computational cost, while enjoying the benefits of finetuning the entire model. This yields a simple and effective method for multi-task learning, in which different tasks do not interfere with one another, and yet share most of the resources at inference time. The efficiency of SubTuning is illustrated in the disclosure across multiple tasks, and using different network architectures and pretraining methods.

The techniques described in further detail herein may be performed via any suitable type of computing platform(s) configured to perform neural network training and/or to use a trained neural network in accordance with any suitable type of application. For example, the techniques disclosed herein may be implemented as part of an autonomous or semi-autonomous vehicle having any suitable level of vehicle autonomy, with the training being executed onboard the vehicle or another suitable device, and in the latter case the trained neural network may then be deployed to the autonomous vehicle platform. The techniques disclosed herein are not limited to use in autonomous vehicle applications, and instead may be implemented in accordance with any suitable neural network training system that may benefit from the Sub-Tuning process. Moreover, although described herein in the context of a neural network, the techniques described herein may be applied and/or extended to any suitable type of machine learning architecture that utilizes multiple layers and accompanying weights that are tuned.

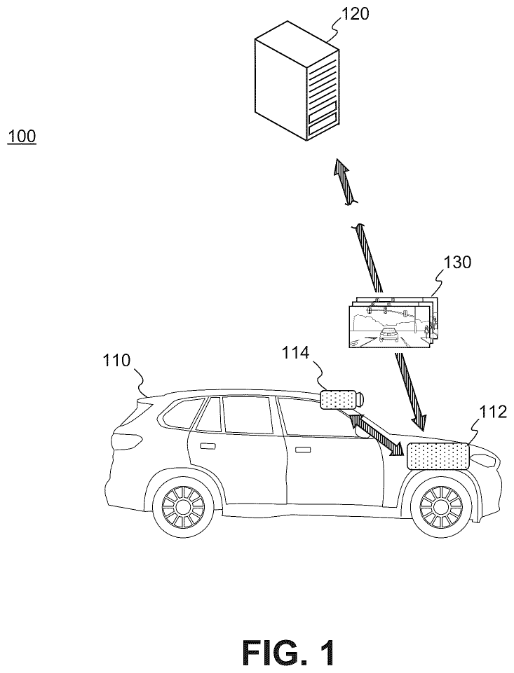

FIG. 1 is a diagrammatic illustration of an example system 100 for implementing the disclosed embodiments. As shown in FIG. 1, system 100 may include a vehicle 110 and a server 120. Vehicle 110 may communicate with server 120 via one or more networks (e.g., over a cellular network and/or the Internet, etc.) through wireless communication paths, as shown. For example, vehicle 110 may capture various data using onboard sensors and may provide the captured data (e.g., data 130) to server 120. In some embodiments, data 130 may include various image data captured by vehicle 110, as indicated in FIG. 1. For example, vehicle 110 may include one or more image capture devices (e.g., cameras), such as image capture device 114 for capturing images of the environment of vehicle 110. Vehicle 110 may also include a processing device 112 for processing various data collected by vehicle 110 and/or received from server 120. In some embodiments, system 100 may include various other computer devices, such as laptops, tablets, mobile devices, desktop computers, or the like which may be used to train a model. Accordingly, the disclosed techniques are not limited to any particular form of device.

In some embodiments, vehicle 110 may be an autonomous vehicle. As used throughout this disclosure, the term “autonomous vehicle” refers to a vehicle capable of implementing at least one navigational change without driver input. A “navigational change” refers to a change in one or more of steering, braking, or acceleration of the vehicle. To be autonomous, a vehicle need not be fully automatic (e.g., fully operational without a driver or without driver input). Rather, an autonomous vehicle includes those that can operate under driver control during certain time periods and without driver control during other time periods. Autonomous vehicles may also include vehicles that control only some aspects of vehicle navigation, such as steering (e.g., to maintain a vehicle course between vehicle lane constraints), but may leave other aspects to the driver (e.g., braking). In some cases, autonomous vehicles may handle some or all aspects of braking, speed control, and/or steering of the vehicle.

As human drivers typically rely on visual cues and observations to control a vehicle, transportation infrastructures are built accordingly, with lane markings, traffic signs, and traffic lights are all designed to provide visual information to drivers. In view of these design characteristics of transportation infrastructures, an autonomous vehicle may include a camera and a processing device that analyzes visual information captured from the environment of the vehicle. The visual information may include, for example, components of the transportation infrastructure (e.g., lane markings, traffic signs, traffic lights, etc.) that are observable by drivers and other obstacles (e.g., other vehicles, pedestrians, debris, etc.). Additionally, an autonomous vehicle may also use stored information, such as information that provides a model of the vehicle's environment when navigating. For example, the vehicle may use GPS data, sensor data (e.g., from an accelerometer, a speed sensor, a suspension sensor, etc.), and/or other map data to provide information related to its environment while the vehicle is traveling, and the vehicle (as well as other vehicles) may use the information to localize itself on the model.

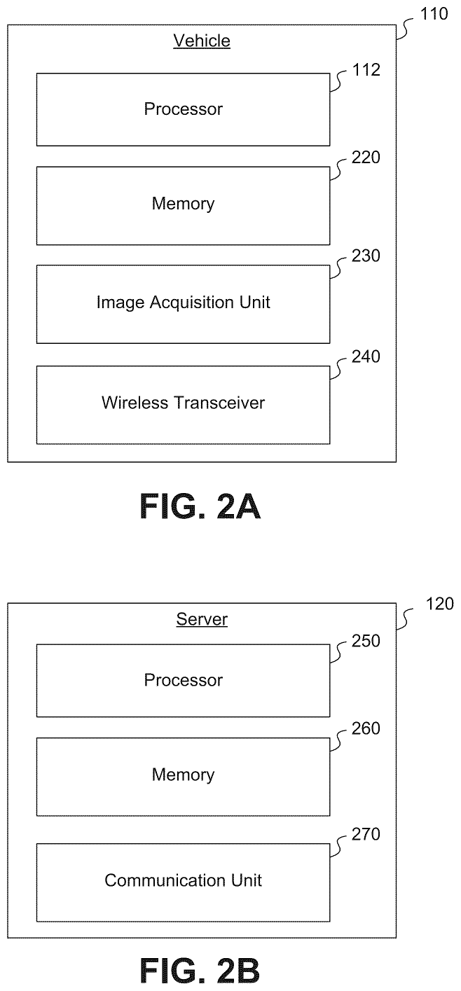

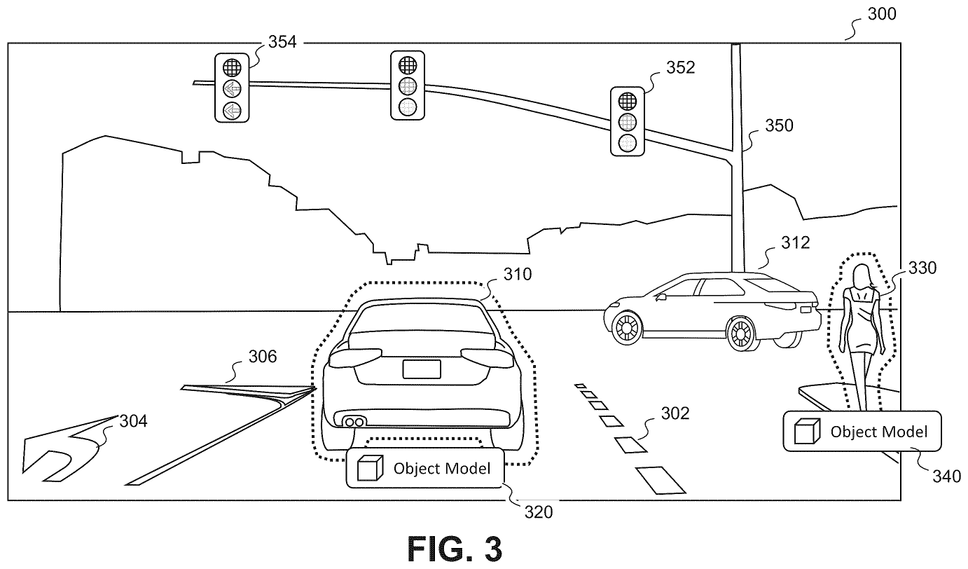

FIG. 2A is a block diagram representation of vehicle 110 consistent with the disclosed embodiments. As discussed above, vehicle 110 may include a processing device 112. As shown in FIG. 2A, vehicle 110 may include various additional components, such as memory 220, image acquisition unit 230, and wireless transceiver 240. While various additional components are shown in FIG. 2A by way of example, one of skill in the art would recognize that vehicle 110 may include additional components not shown in FIG. 2A. For example, host vehicle 110 may include various input/output components (e.g., a user interface), actuators, databases, sensors, or the like, not explicitly shown in FIG. 2A.

Consistent with the disclosed embodiments, processing device 112 may comprise various types of devices. For example, processing device 112 may take the form of, but is not limited to, a microprocessor, embedded processor, or the like, or may be integrated in a system on a chip (SoC). Furthermore, according to some embodiments, processing device 112 may be from the family of processors manufactured by Intel®, AMD®, Qualcomm®, Apple®, NVIDIA®, or the like. Processing device 112 may also be based on the ARM architecture, a mobile processor, or a graphics processing unit, etc.

In some embodiments, processing device 112 may include any of the EyeQ series of processor chips available from Mobileye®. These processor designs each include multiple processing units with local memory and instruction sets. Such processors may include video inputs for receiving image data from multiple image sensors and may also include video out capabilities. In one example, the EyeQ2® uses 90 nm-micron technology operating at 332 Mhz. The EyeQ2® architecture consists of two floating point, hyper-thread 32-bit RISC CPUs (MIPS32® 34K® cores), five Vision Computing Engines (VCE), three Vector Microcode Processors (VMP®), Denali 64-bit Mobile DDR Controller, 128-bit internal Sonics Interconnect, dual 16-bit Video input and 18-bit Video output controllers, 16 channels DMA and several peripherals. The MIPS34K CPU manages the five VCEs, three VMP™ and the DMA, the second MIPS34K CPU and the multi-channel DMA as well as the other peripherals. The five VCEs, three VMP® and the MIPS34K CPU can perform intensive vision computations required by multi-function bundle applications. In another example, the EyeQ3®, which is a third generation processor and is six times more powerful that the EyeQ2®, may be used in the disclosed embodiments. In other examples, the EyeQ4® and/or the EyeQ5® may be used in the disclosed embodiments. Of course, any newer or future EyeQ processing devices may also be used together with the disclosed embodiments.

In some embodiments, processing device 112 may include multiple processing devices. For example, processing device 112 may include various devices, such as a controller, an image preprocessor, a central processing device (CPU), a graphics processing device (GPU), support circuits, digital signal processors, integrated circuits, memory, or any other types of devices for image processing and analysis. The image preprocessor may include a video processor for capturing, digitizing and processing the imagery from the image sensors. The CPU may comprise any number of microcontrollers or microprocessors. The GPU may also comprise any number of microcontrollers or microprocessors. The support circuits may be any number of circuits generally well known in the art, including cache, power supply, clock, and input-output circuits. The memory may store software that, when executed by the processor, controls the operation of the system. The memory may include databases and image processing software. The memory may comprise any number of random access memories, read only memories, flash memories, disk drives, optical storage, tape storage, removable storage and other types of storage. In one instance, the memory may be separate from the processing device 112. In another instance, the memory may be integrated into the processing device 112.

Any of the processing devices disclosed herein may be configured to perform certain functions. Configuring a processing device, such as any of the described EyeQ processors or other controller or microprocessor, to perform certain functions may include programming of computer executable instructions and making those instructions available to the processing device for execution during operation of the processing device. In some embodiments, configuring a processing device may include programming the processing device directly with architectural instructions. For example, processing devices such as field-programmable gate arrays (FPGAs), application-specific integrated circuits (ASICs), and the like may be configured using, for example, one or more hardware description languages (HDLs).

Memory 220 may include one or more storage devices configured to store instructions used by processing device 112 to perform functions related to vehicle 110. The disclosed embodiments are not limited to particular software programs or devices configured to perform dedicated tasks. For example, memory 220 may store a single program, such as a user-level application, that performs the functions associated with the disclosed embodiments, or may comprise multiple software programs. Additionally, processor 210 may, in some embodiments, execute one or more programs (or portions thereof) remotely located from vehicle 110. Furthermore, memory 220 may include one or more storage devices configured to store data for use by the programs. Memory 220 may include, but is not limited to a hard drive, a solid state drive, a CD-ROM drive, a peripheral storage device (e.g., an external hard drive, a USB drive, etc.), a network drive, a cloud storage device, or any other storage device.

Memory 220 may include software instructions that when executed by a processor, may control operation of various aspects of vehicle 110. These memory units may include various databases and image processing software, as well as a trained system, such as a neural network, or a deep neural network, for example. The memory units may include random access memory (RAM), read only memory (ROM), flash memory, disk drives, optical storage, tape storage, removable storage and/or any other types of storage. In some embodiments, memory 220 may be separate from processing device 112. In other embodiments, these memory units may be integrated into processing device 112.

Image acquisition unit 230 may include various components for acquiring and/or processing images from an environment of vehicle 110. Image acquisition unit 230 may include any number of image acquisition devices and components depending on the requirements of a particular application. In some embodiments, image acquisition unit 230 may include one or more image capture devices (e.g., cameras), such as image capture device 114. Vehicle 110 may also include a data interface communicatively connecting processing device 112 to image acquisition unit 230. For example, the data interface may include any wired and/or wireless link or links for transmitting image data acquired by image accusation unit 230 to processing device 112.

The image capture devices included on vehicle 110 as part of the image acquisition unit 230 may be positioned at any suitable location. In some embodiments, image capture device 114 may be located in the vicinity of the rearview mirror. This position may provide a line of sight similar to that of the driver of vehicle 110, which may aid in determining what is and is not visible to the driver. Image capture device 114 may be positioned at any location near the rearview mirror, but placing image capture device 114 on the driver side of the mirror may further aid in obtaining images representative of the driver's field of view and/or line of sight.

Other locations for the image capture devices of image acquisition unit 230 may also be used. For example, image acquisition unit 114 may be located on or in a bumper of vehicle 110. Such a location may be especially suitable for image capture devices having a wide field of view. The line of sight of bumper-located image capture devices can be different from that of the driver and, therefore, the bumper image capture device and driver may not always see the same objects. Image acquisition unit 114 may also be located in other locations and may include multiple image capture devices. For example, image acquisition unit 114 may be located on or in one or both of the side mirrors of vehicle 110, on the roof of vehicle 110, on the hood of vehicle 110, on the trunk of vehicle 110, on the sides of vehicle 110, mounted on, positioned behind, or positioned in front of any of the windows of vehicle 110, and mounted in or near light figures on the front and/or back of vehicle 110, etc.

Wireless transceiver 240 may include one or more devices configured to exchange transmissions over an air interface to one or more networks (e.g., cellular, the Internet, etc.) by use of a radio frequency, infrared frequency, magnetic field, or an electric field. Wireless transceiver 240 may use any known standard to transmit and/or receive data (e.g., Wi-Fi, Bluetooth®, Bluetooth Smart, 802.15.4, ZigBee, etc.). Such transmissions can include communications from the host vehicle to one or more remotely located servers. Such transmissions may also include communications (one-way or two-way) between the host vehicle and one or more target vehicles in an environment of the host vehicle (e.g., to facilitate coordination of navigation of the host vehicle in view of or together with target vehicles in the environment of the host vehicle), or even a broadcast transmission to unspecified recipients in a vicinity of the transmitting vehicle.

Wireless transceiver 240 may and/or receive data over one or more networks (e.g., cellular networks, the Internet, etc.). For example, wireless transceiver 240 may upload data collected by vehicle 110 to server 120, and download data from server 120. Via wireless transceiver 240, vehicle 110 may receive, for example, periodic or on demand updates to data stored in a map database or memory 220. Similarly, wireless transceiver 240 may upload any data (e.g., images captured by image acquisition unit 230, data received by position sensors or other sensors, vehicle control systems, etc.) from by vehicle 110 and/or any data processed by processing device 112 to server 120.

FIG. 2B is a block diagram representation of a server 120, consistent with the disclosed embodiments. As indicated in FIG. 2B, server 120 may include at least one processing device 250, at least one memory 260, and at least one communication unit 270. Processing device 250 may be configured to execute computer codes or instructions stored in memory 260 to perform various functions. For example, processing device 250 may analyze the navigation information received from vehicle 110, and generate an autonomous vehicle road navigation model based on the analysis. Processing device 250 may control communication unit 270 to distribute the autonomous vehicle road navigation model to one or more autonomous vehicles (e.g., vehicle 110). Processing device 250 may be similar to or different from processing device 110.

Server 120 may include at least one memory 260, such as a hard drive, a compact disc, a tape, etc. Memory 260 may be similar to or different from memory 220. For example, memory 260 may include various databases and image processing software, as well as a trained system, such as a neural network, or a deep neural network, for example. Memory 260 may be a non-transitory memory, such as a flash memory, a random access memory, etc. Memory 260 may be configured to store data, such as computer codes or instructions executable by a processor (e.g., processor 250), map data, an autonomous vehicle road navigation model, and/or navigation information received from vehicle 110.

Server 120 may further include a communication unit 270, which may include both hardware components (e.g., communication control circuits, switches, and antenna), and software components (e.g., communication protocols, computer codes). For example, communication unit 270 may include at least one network interface. Server 120 may communicate with vehicle 110 (and various other vehicles) through communication unit 270. For example, server 120 may receive, through communication unit 270, navigation information transmitted from vehicle 110. Server 120 may distribute, through communication unit 270, the autonomous vehicle road navigation model to one or more autonomous vehicles.

Consistent with the disclosed embodiments, server 120 and/or vehicle 110 may be configured to analyze various images to detect objects represented in the images. For example, memory 220 of vehicle 110 may include instructions for detecting a set of features within images, such as lane markings, vehicles, pedestrians, road signs, highway exit ramps, traffic lights, hazardous objects, and the like. Based on the analysis, processing device 112 may cause one or more navigational responses in vehicle 110, such as a turn, a lane shift, a change in acceleration, and the like. Similarly, server 120 may be configured to detect objects in image data uploaded from vehicle 110. Based on the analysis, server 120 may be configured to store locations of detected object in a navigational map, which may be distributed to vehicle 110 and other vehicles for autonomous navigation.

In some embodiments, server 120 and/or vehicle 110 may implement techniques associated with a trained system (such as a neural network or a deep neural network). For example, a neural network may be trained to detect vehicles, pedestrians, lane marks, or other objects represented in images captured by vehicle 110. In some embodiments, a training set of images may be provided to a machine learning algorithm to generate a trained model. The training set of images may be labeled to designate an object represented in the images. As a result of the training process, the neural network may be configured to detect one or more objects in other images. Various other training or machine learning algorithms may be used, including a logistic regression, a linear regression, a regression, a random forest, a K-Nearest Neighbor (KNN) model, a K-Means model, a decision tree, a cox proportional hazards regression model, a Naïve Bayes model, a Support Vector Machines (SVM) model, a gradient boosting algorithm, or any other form of machine learning model or algorithm.

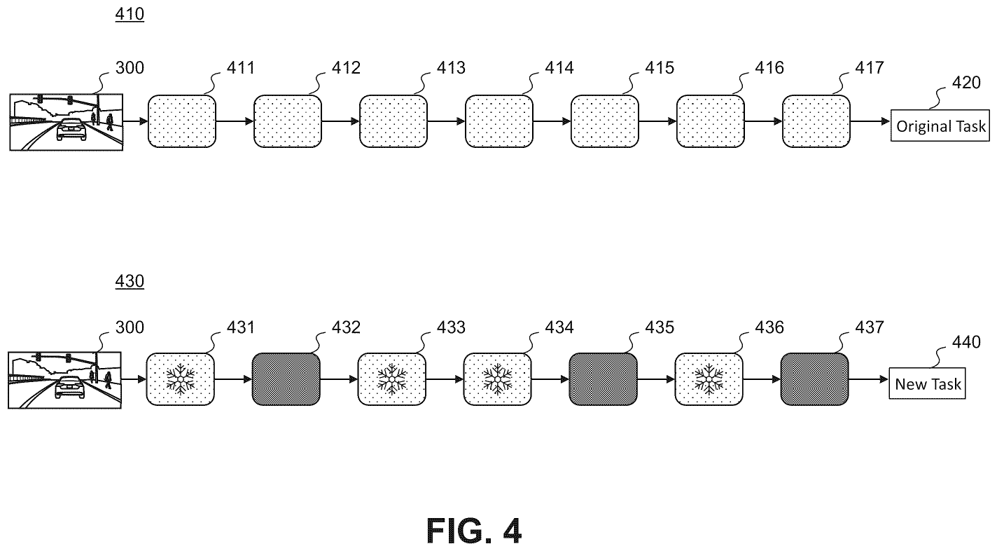

FIG. 3 illustrates an example image 300 that may be processed using a trained system, consistent with the disclosed embodiments. For example, image 300 may represent an image captured by vehicle 110 using image capture device 114. Image 300 may be analyzed using processing device 112, processing device 250, or various other processing devices of system 100. FIG. 3 may include representations of various objects that may be detected by vehicle 110 and/or server 120. For example, image 300 may include vehicles 310 and 312, road markings 302 and 304, a median or curb 306, a pedestrian 330, a pole 350, and traffic lights 352 and 354. The various objects shown in FIG. 3 are provided by way of example, and the disclosed techniques are not limited to detection of any particular object or type of object.

As indicated above, server 120 and/or vehicle 110 may implement various models for detecting objects in image 300. For example, an object model 320 may be trained to detect vehicles in image 300, such as image 310. Similarly, an object model 340 may be trained to detect pedestrians in image 300, such as pedestrian 330. In some embodiments, different models may be implemented for performing different tasks. For example, object model 320 may be trained specifically to identify vehicles in image 300 (and various other images), whereas object model 340 may be trained specifically to identify pedestrians. Accordingly, vehicle 110 and/or server 120 may access and/or implement multiple trained models for performing different tasks. For example, vehicle 110 may include a plurality of trained models for detecting different objects within images and may perform various navigation actions based on detected objects. Similarly, server 120 may include a plurality of trained models for detecting different objects within images and may generate navigational maps based on the detected objects. One of skill in the art would recognize that, while object detection and/or classification is used by way of example throughout the present disclosure, the same or similar techniques may be implemented for any other form of task requiring a trained system or model.

In some embodiments, these techniques may require multiple trained models, each of which may be trained to perform different tasks (e.g., detecting different objects, etc.). While the use of multiple trained models may provide a robust system for image analysis or other techniques, the development of multiple models can be highly resource intensive. For example, each model may be trained using datasets consisting of thousands, hundreds of thousands, or millions of training images. The sheer volume of the training datasets thus places a significant demand on storage, processing, and network bandwidth requirements. Moreover, depending on the type of trained model, each of the training images may require labeling to enable the system to be trained to perform a specific task. Labeling images is often performed manually and thus may require thousands of hours of analysis by human operators to develop a robust set training data. Because each model is designed to perform different tasks, the images and/or labels often cannot be shared among tasks and thus the resource demand increases greatly as the number of separate tasks increase. Any shortcuts that can be achieved for training one model based on a previously trained model may thus provide significant improvements in efficiency and/or performance for a system using trained models.

For example, transfer learning from a large pretrained model provides a method for achieving optimal performance on a diverse range of machine learning tasks in both Computer Vision and Natural Language Processing. Traditionally, neural networks are trained “from scratch,” where at the beginning of the training the weights of the network are randomly initialized. In transfer learning, however, the weights of a model that was already trained on a different task may be used as the starting point for training on the new task, instead of using random initialization. In this approach, the final (readout) layer of the model is typically replaced by a new “head” adapted for the new task, and the rest of the model (the backbone) is tuned starting from the pretrained weights. The use of a pretrained backbone allows leveraging the knowledge acquired from a large dataset, resulting in faster convergence time and improved performance, particularly when training data for the new downstream task is scarce.

The most common approaches for transfer learning are linear probing and finetuning. In linear probing, only the linear readout head is trained on the new task, while the weights of all other layers in the model are frozen at their initial (pretrained) values. This method is very fast and efficient in terms of the number of parameters trained, but it can be suboptimal due to its low capacity to fit the model to the new training data. Alternatively, it is also common to finetune all the parameters of the pretrained model to the new task. This method typically achieves better performance than linear probing, but it is often more costly in terms of training data and compute.

The embodiments disclosed herein provide a simple alternative method, which serves as a middle ground between linear probing and full finetuning. For example, the disclosed embodiments allow for training a carefully chosen small subset of layers in the network. This method, referred to herein as “SubTuning,” allows finding an optimal point between linear probing and full finetuning. SubTuning enjoys the best of both worlds: it is efficient in terms of the number of trained parameters, while still leveraging the computational capacity of training layers deep in the network. As demonstrated herein, SubTuning is a preferable transfer learning method when data is limited or corrupted, or in a multi-task setting with computational constraints. The disclosed methods thus provide significant improvements over linear probing and finetuning, as well as other recent methods for parameter-efficient transfer-learning (e.g., Head2Toc and LoRA).

For example, the SubTuning algorithm bridges the gap between linear probing and full finetuning by selectively training a subset of layers in the neural network. This approach offers a more flexible and efficient solution for transfer learning, particularly in situations where data is scarce or compromised, and computational resources are limited. The disclosed techniques also provide an improved understanding of finetuning through the concept of the finetuning profile, a valuable tool that sheds new light on the importance of individual layers during the finetuning process, as discussed further below. The disclosed SubTuning techniques provide an effective algorithm that selectively finetunes specific layers based on a greedy selection strategy using the finetuning profile. SubTuning frequently surpasses the performance of competing transfer learning methods in various tasks involving limited or corrupted data.

Further, SubTuning provides improvements in the efficacy and computational run-time efficiency in the context of multi-task learning (“MTL”). This approach enables the deployment of multiple networks finetuned for distinct downstream tasks with minimal computational overhead. For example, neural networks are often used for solving multiple tasks. These tasks typically share similar properties, and solving them concurrently allows sharing common features that may capture knowledge that is relevant for all tasks. However, MTL also presents significant challenges, such as negative transfer, loss balancing, optimization difficulty, data balancing and shuffling. While these problems can be mitigated by careful sampling of the data and tuning of the loss function, these solutions are often fragile. In a related setting called Continual Learning, adding new tasks needs to happen on-top of previously deployed tasks, while losing access to older data due to storage or privacy constraints, complicating matters even further. Using the embodiments disclosed herein, new tasks can be efficiently added using SubTuning, without compromising performance or causing degradation of previously learned tasks.

In the process of finetuning deep neural networks, a crucial yet often undervalued aspect is the unequal contribution of individual layers to the model's overall performance. This variation in layer importance calls into question prevalent assumptions and requires a more sophisticated approach to effectively enhance the finetuning process. By selectively training layers, it is possible to strategically allocate computational resources and improve the model's performance.

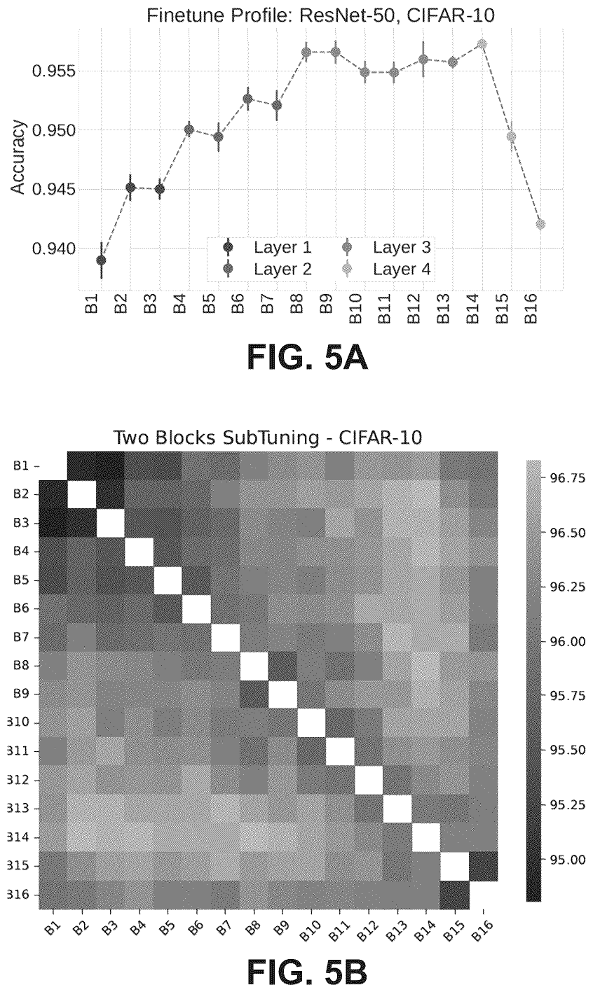

FIG. 4 illustrates an example technique for selective finetuning of a model, consistent with the disclosed embodiments. As shown, an initial pretrained model 410 may be trained for performing an original task 420. In some embodiments, original task 420 may include a computer vision task. For example, original task 420 may include detecting one type of objects (e.g., vehicles) in images, such as detecting vehicle 310 in image 300, as described above. Accordingly, pretrained model 410 may correspond to object model 320 in this example. Pretrained model 410 may include a plurality of pretrained weights 411-417, as indicated in FIG. 4. Each of pretrained weights 411-417 may be associated with a preexisting value, which may be determined through a training process for pretrained model 410. For example, pretrained model 410 may be trained using a set of training images labeled with vehicles. Accordingly, pretrained model 410 may be configured to detect vehicle 310 in image 300 based on pretrained weights 411-417. While object detection is provided by way of example, it is to be understood that pretrained model 410 may include various other forms of trained models including weights, such as a natural language processing model, or the like.

Consistent with the disclosed embodiments, an additional trained model 430 may be developed to perform a new task 440. In some embodiments, new task 440 may include a computer vision task. For example, new task 440 may include detecting another type of objects (e.g., pedestrians) in images, such as detecting pedestrian 330 in image 300, as described above. Accordingly, additional trained model 430 may correspond to object model 340 in this example. To conserve resources required for training additional trained model 430, pretrained model 410 may be used as a starting point. Using traditional finetuning techniques, each of pretrained weights 411-417 may be finetuned to achieve new task 440. However, as described above, this finetuning technique is often costly in terms of training data and computational demands.

In training additional trained model 430, a strategically selected subset of layers may be finetuned (which may include the final readout layer), while the rest of the layers are frozen or maintained in their pretrained values. For example, additional trained model 430 may include weights 431-437. In this example, pretrained weights 412, 415, and 417 from pretrained model 410 may be selected for finetuning, whereas pretrained weights 411, 413, 414, and 416 may be frozen. Accordingly, the values of weights 431, 433, 434, and 436 may correspond to the values of pretrained weights 411, 433, 434, and 436, respectively. Weights 432, 435, and 437 may thus be finetuned for performing new task 440. Accordingly, additional trained model 430 may be trained much more efficiently as compared to if additional trained model 430 were trained without any preexisting values for weights 431-437 or if all of pretrained weights 411-417 were finetuned.

Various methods may be used to select the weights from pretrained model 410 to be finetuned to generate additional trained model 430. To pinpoint the essential components within the network, two related methods are discussed herein: constructing the finetuning profile by scanning for the optimal layer (or block of layers) with a complexity of O(num layers), and a Greedy SubTuning algorithm, where the finetuning profile is iteratively leveraged to select k-layers one by one, while using a higher complexity of O(num layers·k).

A comprehensive analysis of the significance of finetuning different components of the network was used to guide the choice of the subset of layers to be used for SubTuning. For example, this includes a series of experiments in which a specific subset of consecutive layers are fixed within the network and only these layers are finetuned, while maintaining the initial (pretrained) weights for the remaining layers.

As an illustrative example, a ResNet-50 neural network is pretrained on the ImageNet dataset, and finetuned on the CIFAR-10 dataset, replacing the readout layer of ImageNet (which has 1000 classes) by a readout layer adapted to CIFAR-10 (with 10 classes). As noted, not all the weights of the network are finetuned, but rather only a few layers from the model (as well as the readout layer) are optimized. Specifically, in this example, as the ResNet-50 architecture is composed of 16 blocks (i.e., ResBlocks), 16 experiments are run, where in each experiment only one block is trained, fixing the weights of all other blocks at their initial (pretrained) values. The accuracy of the model as a function of the block that is trained may then be plotted. The resulting graph is referred to herein as the finetuning profile of the network.

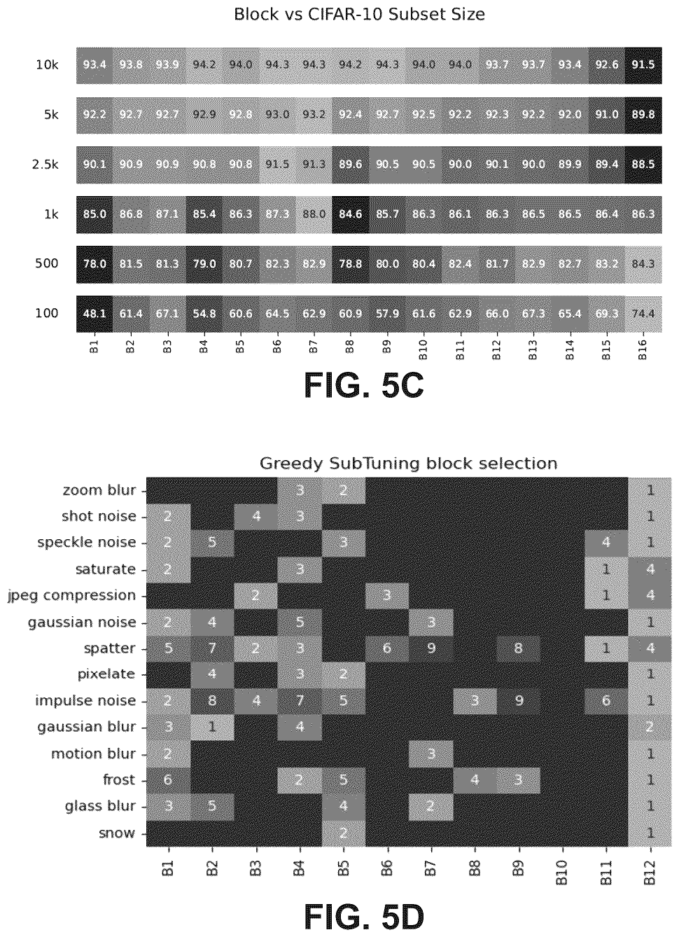

FIG. 5A provides an illustrative example of a finetuning profile of a network, consistent with the disclosed embodiments. Specifically, FIG. 5A shows the finetuning profile of a ResNet-50 architecture pretrained on ImageNet and finetuned on CIFAR-10, as described above. On the x-axis, 16 res-blocks are shown, where each Layer (with capital L) corresponds to a drop in spatial resolution. Following a similar protocol, finetuning profiles for various combinations of architectures (e.g., ResNet-18, ResNet-50, and VIT-B/16), pretraining methods (e.g., supervised and DINO (Deeper Into Neural Networks)), and target tasks (CIFAR-10, CIFAR-100 and Flower 102) may be computed.

For most architectures and datasets, the importance of a layer cannot be predicted by simply observing properties such as the depth of the layer, the number of parameters in the layer or its spatial resolution. In fact, the same architecture can have distinctively different finetuning profiles when trained on a different downstream task or from different initialization. While layers closer to the input tend to contribute less to the finetuning process, the performance of the network typically does not increase monotonically with the depth or with the number of parameters. For example, in the ResNet architectures, deeper blocks have more parameters, while for ViT all layers have the same amount of parameters. And after a certain point the performance often starts decreasing when training deeper layers. For example, in the finetuning profile of ResNet-50 finetuned on the CIFAR-10 dataset, as shown in FIG. 5A, fine-tuning Block 13 results in significantly better performance compared to optimizing Block 16, which is deeper and has many more parameters. The effect of finetuning more consecutive blocks was also considered. When evaluating the finetuning profiles for training groups of 2 and 3 consecutive blocks, for example, the results indicate that finetuning more layers improves performance, and also makes the finetuning profile more monotonic.

### Greedy Selection

The discussion thus far prompts an inquiry into the consequences of training arbitrary (possibly non-consecutive) layers. First, it can be observed that different combinations of layers admit non-trivial interactions, and therefore simply choosing subsets of consecutive layers may be suboptimal. For example, FIG. 5B shows a plot of the accuracy of training all possible subsets of two blocks from ResNet-50. As shown in FIG. 5B the optimal performance is achieved by Block 2 and Block 14. Therefore, a careful selection of layers to trained may be needed.

A brute-force approach for testing all possible subsets of k layers would result in a computational burden of O(num layers^{k}). To circumvent this issue, an efficient greedy algorithm with a cost of O(num layers·k) may be introduced. This algorithm iteratively selects the layer that yields the largest marginal contribution to validation accuracy, given the currently selected layers. The layer selection process is halted when the marginal benefit falls below a predetermined threshold, ¿, after which the chosen layers are finetuned. The pseudo-code for this algorithm is delineated as follows:

Algorithm 1 Greedy-SubTuning

| | |
|---|---|
| 1: | procedure GREEDYSUBSETSELECTION(model, all_layers, ε) |
| 2: | S ← { }, n ← \|all_layers\| |
| 3: | A_{best} = 0 |
| 4: | for i = 1 to n do |
| 5: | Aᵢₜₑᵣ ← 0, L_{best} ← null |
| 6: | for L ∈ (all_layers − S) do |
| 7: | S′ ← S ∪ {L} |
| 8: | A_{new} ← evaluate(model, S′) |
| 9: | if A_{new} > Aᵢₜₑᵣ then |
| 10: | L_{best} ← L, Aᵢₜₑᵣ ← A_{new} |
| 11: | end if |
| 12: | end for |
| 13: | if Aᵢₜₑᵣ > A_{best} + ε then |
| 14: | A_{best} ← Aᵢₜₑᵣ , S ← S ∪ {L_{best}} |
| | (if no layers helps sufficiently, we stop) |
| 15: | else |
| 16: | Break |
| 17: | end if |
| 18: | end for |
| 19: | return S |
| 20: | end procedure |

We note that such greedy optimization may be used for subset selection in various combinatorial problems, and may approximate the optimal solution under certain assumptions. SubTuning results in comparable performance to full finetuning even for full datasets.

Theoretical justification for using Greedy SubTuning when data size is limited is provided as follows: Denote by θ∈ [symbol] ^{T} an initial set of pretrained parameters, and by f_{θ} the original network that uses these parameters. In standard finetuning, θ is tuned on the new task, resulting in some new set of parameters \tilde{θ}, satisfying ∥θ−θ∥≥Δ. Using first-order taylor expansion, when Δ is small:

$${f}_{\tilde{θ}} ( x ) \approx {f}_{θ} ( x ) + 〈 ∇ {f}_{θ} ( x ) , \tilde{θ} - θ 〉 = 〈 {ψ}_{θ} ( x ) , w 〉$$

for some mapping of the input ve (typically referred to as the Neural Tangent Kernel), and some vector w of norm≤Δ. By optimizing w over some dataset of size m, using standard norm-based generalization bounds, the generalization of the resulting classifier is

$$O ( \frac{\sqrt{r} Δ}{\sqrt{m}} ) ,$$

where r is the number of parameters in the network. This means that if the number of parameters is large, many samples are needed to achieve good performance.

SubTuning can potentially lead to much better generalization guarantees. Since in SubTuning only a subset of the network's parameters are trained, it may be expected that the generalization depends only on the number of parameters in the trained layers. This is not immediately true, since the Greedy SubTuning algorithm reuses the same dataset while searching for the optimal subset, which can potentially increase the sample complexity (i.e., when the optimal subset is “overfitted” to the training set). However, a careful analysis reveals that the Greedy SubTuning indeed allows improved generalization guarantees, and that the subset optimization only adds logarithmic factors to the sample complexity. Assuming a Greedy SubTuning over a network with L layers, tuning at most k layers with r′<<r parameters, the generalization error of the resulting classifier is

$$O ( \frac{\sqrt{{r}^{′}} Δ log ( kL )}{\sqrt{m}} ) .$$

The following discussion addresses finetuning in the low-data regime. As mentioned, transfer learning is a common approach in this setting, leveraging the power of a model that is already pretrained on large amounts of data. In this context, SubTuning can outperform both linear probing and full finetuning, as well as other parameter efficient transfer learning methods. SubTuning is also beneficial when data is corrupted.

### Evaluating SubTuning in Low-Data Regimes

SubTuning has significant advantages when data is scarce, compared to other transfer learning methods. Beside linear probing and finetuning, SubTuning also has advantages over highly performing algorithms in the low data regime: Head2Toe and LoRA. Head2Toe is a method for bridging the gap between linear probing and finetuning, which operates by training a linear layer on top of features selected from activation maps throughout the network. LoRA is a method that trains a “residual” branch (mostly inside a Transformer) using a low rank decomposition of the layer.

The table below illustrates the performance of ResNet-50 and ViT-b/16 pretrained on ImageNet and finetuned on datasets from VTAB-1k. FT denotes finetuning while LP stands for linear probing.

| | ResNet50 | | | | ViT-b/16 | | | |
|---|---|---|---|---|---|---|---|---|
| | CIFAR-100 | Flowers102 | Caltech101 | DMLAB | CIFAR-100 | Flowers102 | Caltech101 | DMLab |
| SubTuning | 54.6 | 90.5 | 86.5 | 51.2 | 68 | 97.7 | 86.5 | 36.4 |
| H2T | 47.1 | 85.6 | 88.8 | 43.9 | 58.2 | 85.9 | 87.3 | 41.6 |
| FT | 33.7 | 87.3 | 78.7 | 48.2 | 47.8 | 91.2 | 80.7 | 34.3 |
| LP | 35.4 | 64.2 | 67.1 | 36.3 | 29.9 | 84.7 | 72.7 | 31 |
| LoRA | — | — | — | — | 40.4 | 88.3 | 79.2 | 36.4 |

First, the performance of SubTuning on the VTAB-1k benchmark is evaluated, focusing on the CIFAR-100, Flowers 102, Caltech 101, and DMLab datasets using the 1k examples split specified in the protocol. The Greedy SubTuning approach is applied to select the subset of layers to finetune, as described above. For layer selection, the training dataset was divided into five parts and performed five-fold cross-validation. The official PyTorch ResNet-50 pretrained on ImageNet and ViT-b/16 pretrained on ImageNet-22k were used. As indicated in the table above, SubTuning frequently outperforms competing methods and remains competitive in other cases.

The optimal layer selection for a given task is contingent upon various factors, such as the architecture, the task itself, and the dataset size. In investigating the impact of dataset size on the performance of SubTuning with different layers by comparing the finetuning of a single residual block to linear probing and finetuning on CIFAR-10 with varying dataset sizes was also investigated. FIG. 5C illustrates the results of Single block SubTuning of ResNet-50 on CIFAR-10. The y axis is dataset size, x axis is the chosen block. With growing dataset sizes, training earlier layers proves to be more beneficial. Thus, as shown in FIG. 5C, layers closer to the output exhibit superior performance when training on smaller datasets.

Deep neural networks are known to be sensitive to minor distribution shifts between the source and target domains, which lead to a decrease in their performance. One cost-effective solution to this problem is to collect a small-labeled dataset from the target domain and finetune a pretrained model on this dataset. In a scenario where a large-labeled dataset is available from the source domain, but only limited labeled data is available from the target domain, Greedy SubTuning yields better results compared to finetuning all layers, and also compared to Surgical finetuning, where a large subset of consecutive blocks is trained. Specifically, as compared to linear probing, finetuning, and Surgical finetuning, SubTuning often outperforms and always is competitive with other methods. On average, SubTuning performs 3% better than full finetuning and 2.2% better than Surgical finetuning reproduced in the scenario discussed above setting.

In analyzing the number of residual blocks required for SubTuning, the average accuracy on 3 distribution shifts (glass blur, zoom blur and jpeg compression) and the average performance for the 14 corruptions in CIFAR-10-C was evaluated. Even with as little as 2 appropriately selected residual blocks, SubTuning shows better performance than full finetuning.

Finally, which blocks were used by the Greedy-SubTuning method above was analyzed. FIG. 5D illustrates the selected blocks and their respective order for each dataset. The findings contradict the commonly held belief that only the last few blocks require adjustment. In fact, SubTuning utilizes numerous blocks from the beginning and middle of the network. Furthermore, these results challenge the claim adjusting only the first layers of the network suffices for input-level shifts in CIFAR-10-C. Interestingly, the ultimate or penultimate block was the first layer selected for all corruptions, resulting in the largest performance increase.

So far, the varying impact of different layers on the overall performance of a finetuned model has been discussed, showing that high accuracy can be achieved without training all parameters of the network, provided that the right layers are selected for training. However, SubTuning may also be used for Multi-Task Learning (MTL), as discussed below.

One major drawback of standard finetuning in the context of multi-task learning is that once the model is finetuned on a new task, its weights may no longer be suitable for the original source task (a problem known as catastrophic forgetting). Consider for instance the following multi-task setting, which serves as the primary motivation for this section. For example, assume a large backbone network that was trained on some source task, and is already deployed and running as part of a machine learning system. When presented with a new task, deployed backbone is finetuned on this task, and the new finetuned network is run parallel to the old one. This presents a problem, as now the same architecture must be run twice, each time with a different set of weights. Doing so doubles the cost both in terms of compute (the number of multiply-adds needed for computing both tasks), and in terms of memory and IO (the number of bits required to load the weights of both models from memory). An alternative would be to perform multi-task training for both the old and new task, but this usually results in degradation of performance on both tasks, with issues such as data balancing, parameters sharing and loss weighting cropping up.

Using SubTuning, however, we can efficiently deploy new tasks at inference time with minimal cost in terms of compute, memory and IO, while maintaining high accuracy on the downstream tasks. Instead of training all tasks simultaneously, which can lead to task interference and complex optimization, the disclosed embodiments may include starting with a network pretrained on some primary task, and adding new tasks with SubTuning on top of it. This framework provides assurance that the performance of previously learned tasks will be preserved while adding new tasks.

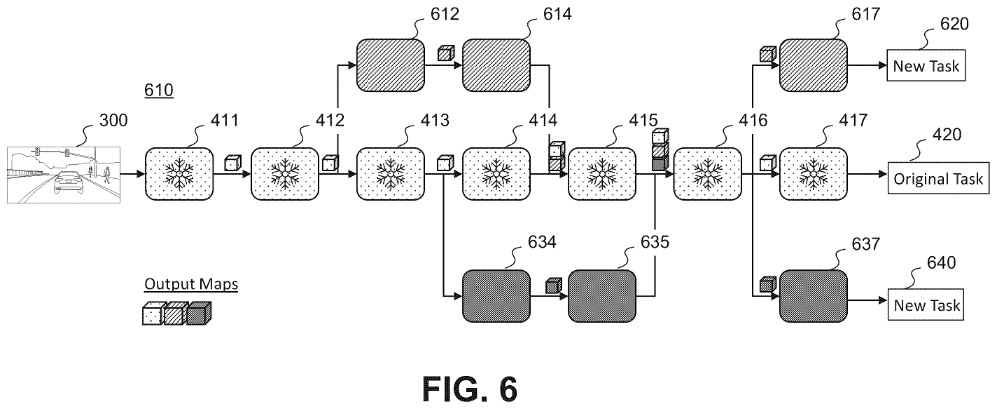

FIG. 6 is an illustration of an example application of SubTuning for multi-task learning, consistent with the disclosed embodiments. As discussed above with respect to FIG. 4, a pretrained model may be trained to perform original task 420 based on pretrained weights 411-417. In a multi-task learning application, pretrained model 410 may be used to train an extended model 610 to perform new tasks 620 and 640 (similar to with new task 440). In this example, however, each new task utilizes a consecutive subset of layers of a network and shares the others. For example, new task 620 utilizes consecutive layers 612 and 614, and new task 640 utilizes consecutive layers 634 and 635. At the end of the split, the outputs of different tasks are concatenated and parallelized along the batch axis for computational efficiency.

It will now be demonstrated how SubTuning improves the computational efficiency of the network at inference time. The following setting of multi-task learning is provided as an example. A network f_{θ} is trained on some task. The network gets an input x and returns an output f_{θ}(x). A new network is to be trained on a different task by finetuning the weights θ, resulting in a new set of weights θ. Now, at inference time, an input x is received an and both f_{θ}(x) and f_{\tilde{θ}}(x) must are to be computed with minimal compute budget. Since it cannot be expected for the overall compute to be lower than just running f_{θ}(x), only the additional cost of computing f_{\tilde{θ}}(x) is measured, given that f_{θ}(x) is already computed.

Since inference time heavily depends on various parameters such as the hardware used for inference (e.g., CPU, GPU, FPGA), the hardware parallel load, the network compilation (i.e., kernel fusion) and the batch size, a crude analysis of the compute requirements is conducted. The two main factors that contribute to computation time are: 1) Computational cost, or the number of multiply-adds (FLOPs) needed to compute each layer and 2) IO, which refers to the number of bits required to read from memory to load each layer's weights.

Performing full finetuning of all layers, in order to compute f_{\tilde{θ}}(x) both the computational cost and the IO are doubled, as now two separate networks, f_{θ} and f_{\tilde{θ}}, are effectively being run with two separate sets of weights. Note that this does not necessarily mean that the computation-time is doubled, since most hardware used for inference does significant parallelization, and if the hardware is not fully utilized when running f_{θ}(x), the additional cost of running f_{\tilde{θ}}(x) in parallel might be smaller. However, in terms of additional compute, full finetuning is the least optimal thing to do.

Consider now the computational cost of SubTuning. For simplicity the case is analyzed where the chosen layers are consecutive, but similar analysis can be applied to the non-consecutive case. Denote by N the number of layers in the network, and assume that the parameters θ differ from the original parameters θ only in the layers [symbol] ₛₜₐᵣₜ through [symbol] _{end} (where 1≤ [symbol] ₛₜₐᵣₜ≤ [symbol] _{end}≤N). Let us separate between two cases: 1) [symbol] _{end} is the final layer of the network and 2) [symbol] _{end} is some intermediate layer.

The case where fend is the final layer is the simplest: the entire compute of f_{θ}(x) and f_{\tilde{θ}}(x) is shared up until the layer [symbol] ₛₜₐᵣₜ (so there is zero extra cost for layers below [symbol] ₛₜₐᵣₜ), and “fork” the network is “forked” and ru the layers of f_{θ} and f_{\tilde{θ}} are run in parallel. In this case, both the compute and the IO are doubled only for the layers between [symbol] ₛₜₐᵣₜ and [symbol] _{end}.

In the second case, where [symbol] _{end} is some intermediate layer, the computational considerations are more nuanced. As in the previous case, the entire computation before layer [symbol] ₛₜₐᵣₜ is shared, with no extra compute. Then the network is “forked,” paying double compute and IO for the layers between [symbol] ₛₜₐᵣₜ and [symbol] _{end}. For the layers after fend, however, the outputs of the two parallel branches (i.e., concatenating them in the “batch” axis) can be “merged” back, and the same network weights for both outputs can be used. This means that for the layers after [symbol] _{end} the compute (i.e., in FLOPs) is doubled, but the IO remains the same (by reusing the weights for both outputs), as illustrated in FIG. 6.

More formally, let c; be the computational-cost of the i-th layer, and let sᵢ be the IO required for the i-th layer. To get a rough estimate of how the IO and compute affect the backbone run-time, consider a simple setting where compute and IO are parallelized. Thus, while the processor computes layer i, the weights of layer i+1 are loaded into memory. The total inference time of the model is then:

$$Compute = max ( 2 {s}_{{ℓ}_{start}} , {c}_{{ℓ}_{start} - 1} ) + {\sum }_{i = {ℓ}_{start}}^{{ℓ}_{end}} 2 max ( {c}_{i} , {s}_{i + 1} ) + {\sum }_{i = {ℓ}_{end} + 1}^{N - 1} max ( 2 {c}_{i} , {s}_{i + 1} ) + 2 {c}_{N}$$

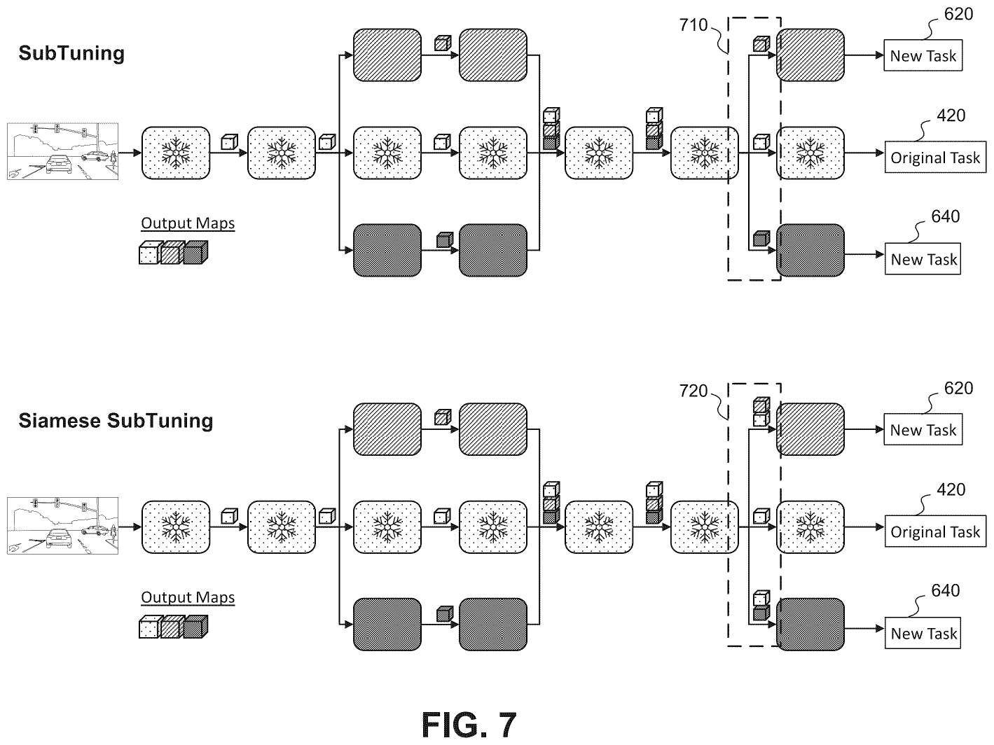

Thus, both deeper and shallower layers can be optimal for SubTuning, depending on the exact deployment environment, workload and whether we are IO or compute bound. The performance vs latency tradeoffs of SubTuning for MTL is empirically investigated by conducting an experiment using ResNet-50 on an NVIDIA A100-SXM-80 GB GPU with a batch size of 1 and resolution 224. 1 and 3 consecutive res-blocks are finetuned and the accuracy is plotted against the added inference cost, as seen in FIG. 7. This way significant performance gains are achieved, with minimal computational cost. However, it is important to mention that the exact choice of which layer gives the optimal accuracy-latency tradeoff can heavily depend on the deployment environment, as the runtime estimation may vary depending on factors such as hardware, job load, and software stack.

Neural networks are now becoming an integral part of software development. In conventional development, teams can work independently and resolve conflicts using version control systems. But with neural networks, maintaining independence becomes difficult. Teams building a single network for different tasks must coordinate training cycles, and changes in one task can impact others. SubTuning offers a viable solution to this problem. It allows developers to “fork” deployed networks and develop new tasks without interfering with other teams. This approach promotes independent development, knowledge sharing, and efficient deployment of new tasks. It also results in improved performance compared to competing transfer learning methods in different settings. In conclusion, SubTuning, along with other efficient finetuning methods, may play a role in the ongoing evolution of software development in the neural network era.

Various additional experimentations with SubTuning are discussed below.

Active Learning with SubTuning

As discussed above, SubTuning is a superior method compared to both finetuning and linear probing when the amount of labeled data is limited. The advantages of SubTuning in the pool-based Active Learning (AL) setting is now explored, where a large pool of unlabeled data is readily available, and additional examples can be labeled to improve the model's accuracy. It is essential to note that in real-world scenarios, labeling is a costly process, requiring domain expertise and a significant amount of manual effort. Therefore, it is crucial to identify the most informative examples to optimize the model's performance.

A common approach in this setting is to use the model's uncertainty to select the best examples. The process of labeling examples in AL involves iteratively training the model using all labeled data, and selecting the next set of examples to be labeled using the model. This process is repeated until the desired performance is achieved or the budget for labeling examples is exhausted.

Examples were selected according to their classification margin. Initially, 100 examples were randomly selected from the CIFAR-10 dataset. At each iteration additional examples are selected and labeled, training with 500 to 10,000 labeled examples that were iteratively selected according to their margin. For example, after training on the initial 100 randomly selected examples, the 400 examples with the lowest classification margin are selected and their labels are revealed. The 500 labeled examples are trained on, before selecting another 500 examples to label to reach 1k examples. When comparing the performance of the model when trained on examples selected by our margin-based rule, to training on subsets of randomly selected examples, and comparing the SubTuning method to full finetuning with and without margin-based selection of examples, SubTuning for AL outperforms full finetuning, and that the selection criterion we use gives significance boost in performance.

### Siamese SubTuning

In the multi-task setting discussed above with respect to FIG. 6, a network f_{θ} is trained on one task, and another network is to be trained by fine-tuning the weights θ for a different task, resulting in new weights θ. At inference time, both f_{θ}(x) and f_{\tilde{θ}}(x) are to be computed, minimizing the additional cost of computing f_{\tilde{θ}}(x), while preserving good performance. Since f_{θ}(x) is computed anyway, its features are available at no extra cost, and they can be combined with the new features. To achieve this, the representations given by f_{θ}(x) and f_{\tilde{θ}}(x) are concatenated before inserting them into the classification head. This method is referred to as Siamese SubTuning.

FIG. 7 illustrates an example Siamese SubTuning technique in comparison to other SubTuning techniques, consistent with the disclosed embodiments. Note that the difference is that, in Siamese SubTuning, the new tasks 620 and 640 now get the original features as input. For example, compare inputs 710 for SubTuning with inputs 720 for Siamese SubTuning.

The effectiveness of Siamese SubTuning was evaluated on multiple datasets and found to be particularly beneficial in scenarios where data is limited. For instance, when finetuning on 5,000 randomly selected training samples from the CIFAR-10, CIFAR-100, and Stanford Cars datasets, Siamese SubTuning with ResNet-18 outperforms standard SubTuning. Both SubTuning and Siamese SubTuning significantly improve performance when compared to linear probing in this setting. For instance, linear probing on top of ResNet-18 on CIFAR-10 achieves 79% accuracy, where Siamese SubTuning achieves 88% accuracy in the same setting.

The comparison of SubTuning and Siamese SubTuning is based on experiments performed on 5,000 randomly selected training samples from CIFAR10, CIFAR100, and Stanford Cars datasets. In evaluating the results, Siamese SubTuning adds a performance boost in the vast majority of architectures, datasets, and block choices.

### Pruning

As discussed above, SubTuning is effective in reducing the cost of adding new tasks for Multi-Task Learning (MTL) while maintaining high performance on those tasks. To further optimize computational efficiency and decrease the model size for new tasks, the concept of channel pruning on the SubTuned component of the model may also be implemented. Two types of pruning, local and global, may be employed to reduce the parameter size and runtime of the model while preserving its accuracy. Local pruning removes an equal portion of channels for each layer, while global pruning eliminates channels across the network regardless of how many channels are removed per layer. For both pruning techniques the weights with the lowest L1 and L2 norms are pruned to meet the target pruning ratio.

The effectiveness of combining channel pruning with SubTuning on the last 3 blocks of ResNet-50 has been demonstrated. Instead of simply copying the weights and then training the blocks, an additional step of pruning before the training is added. This way, the original, frozen, network is pruned only once for all future tasks. As a result, pruning is effective across different parameter targets, reducing the cost with only minor performance degradation. For instance, when using less than 3% of the last 3 blocks (about 2% of all the parameters of ResNet-50), a 94% accuracy is maintained on the CIFAR-10 dataset, compared to about 91% accuracy achieved by linear probing in the same setting.

### Effect of Random Re-Initialization

In the exploration of SubTuning, it was discovered that initializing the weights of the SubTuned block with pretrained weights from a different task significantly improves both the performance and speed of training. Specifically, a block of ResNet-50 was selected, which was pretrained on ImageNet, and finetuned on the CIFAR-10 dataset. When comparing this approach to an alternative method including randomly reinitializing the weights of the same block before finetuning it on the CIFAR-10 dataset, the pretrained weights led to faster convergence and better performance, especially when finetuning earlier layers. In contrast, random initialization of the block's weights resulted in poor performance, even with a longer training time of 80 epochs.

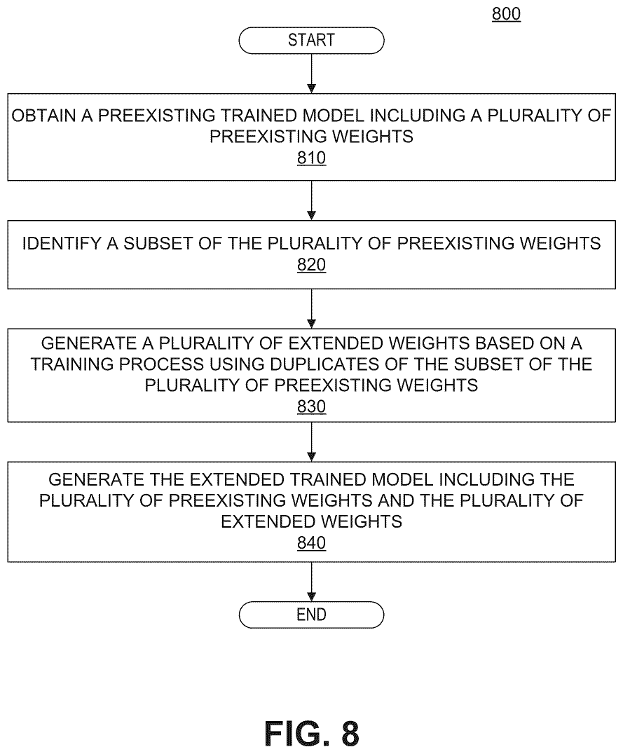

FIG. 8 is a flowchart showing an example process 800 for generating an extended trained model, consistent with the disclosed embodiments. Process 800 may include techniques for generating an extended module using the SubTuning techniques described herein. Process 800 may be performed by at least one processing device, such as processing devices 112 or 250, as described above, or any other processing devices that may be used for training a model. It is to be understood that throughout the present disclosure, the term “processor” is used as a shorthand for “at least one processor.” In other words, a processor may include one or more structures that perform logic operations whether such structures are collocated, connected, or dispersed. In some embodiments, a non-transitory computer readable medium may contain instructions that when executed by a processor cause the processor to perform process 800. Further, process 800 is not necessarily limited to the steps shown in FIG. 8, and any steps or processes of the various embodiments described throughout the present disclosure may also be included in process 800, including those described above with respect to FIGS. 3, 4, 5A-D, 6, and 7.

In step 810, process 800 includes obtaining a preexisting trained model including a plurality of preexisting weights. For example, step 810 may include obtaining pretrained model 410, as described above, which may include pretrained weights 411-417. Each of the plurality of preexisting weights may be associated with a preexisting value. In some embodiments, the preexisting value of each of the plurality of preexisting weights includes a numerical value. For example, the numerical values may be determined through a training process for the preexisting trained model based on a set of training data. In some embodiments, the preexisting trained model may include a neural network.

In step 820, process 800 includes identifying a subset of the plurality of preexisting weights. For example, step 820 may include identifying weights 412, 415, and 417, as discussed above. According to some embodiments, identifying the subset of the plurality of preexisting weights may include selecting the subset of the plurality of preexisting weights based on a comparison of a performance criterion associated with each of the plurality of preexisting weights to a threshold. For example, the preexisting trained model may be trained to perform a first task and the performance criterion associated with each of the plurality of preexisting weights may be determined based on causing the preexisting trained model to perform a second task, where the first task and the second task are different tasks.

In some embodiments, the first task may include identifying a first category of objects represented in one or more images and the second task may include identifying a second category of objects represented in the one or more images, where the first category of objects and the second category of objects are different categories. For example, the first task may include identifying a first category of objects represented in image 300 and the second task may include identifying a second category of objects represented in image 300, as discussed above. Accordingly, the one or more images may be representative of an environment of at least one host vehicle, such as vehicle 110. In some embodiments, the at least one host vehicle may include an autonomous or a semi-autonomous vehicle, as described above.

Various categories of objects may be associated with the first and second tasks, consistent with the disclosed embodiments. For example, the first category of objects may include vehicles and the second category of objects may include another category of object, such as traffic signals, pedestrians, lane markings, signs, or various other objects that may be encountered in the environment of a vehicle. Any other combination of the various objects listed above may also be used. In some embodiments, the categories may include different vehicle types. For example, the first category of objects may include a first type of vehicle and the second category of objects may include a second type of vehicle, where the first type of vehicle and the second type of vehicle are different types. For example, the first type of vehicle may be a sedan and the second type of vehicle may be a truck. As another example, the first type of vehicle may be a sedan and the second type of vehicle may be a motorcycle.

In some embodiments, the tasks may further include an image segmentation process. For example, the first task may include applying an image segmentation process to one or more images and identifying a first category of objects represented in the one or more images. The second task may include identifying a second category of objects represented in the one or more images, where the first category of objects and the second category of objects are different categories.

In step 830, process 800 includes generating a plurality of extended weights based on a training process using duplicates (e.g., copies) of the subset of the plurality of preexisting weights. For example, the training process may include using duplicates of weights 412, 415, and 417. In some embodiments, the training process using the duplicates of the subset of the plurality of preexisting weights may include modifying the preexisting value of each of the duplicates of the subset of the plurality of preexisting weights. For example, the training process may include modifying the value of weights 412, 415, and 417 to generate weights 432, 435, and 437, as described above.

In some embodiments, the preexisting trained model may be trained to perform a first task, and the training process using the duplicates of the subset of the plurality of preexisting weights may include using the duplicates of the subset of the plurality of preexisting weights to perform a second task, where the first task and the second task are different tasks. For example, the first task includes identifying a first category of objects represented in one or more images, wherein the second task includes identifying a second category of objects represented in the one or more images, as described above. As another example, the first task may include applying an image segmentation process to one or more images and identifying a first category of objects represented in the one or more images, and the second task may include identifying a second category of objects represented in the one or more images, as described above.

In step 840, process 800 includes generating the extended trained model, wherein the extended trained model includes the plurality of preexisting weights and the plurality of extended weights. For example, step 840 may include generating additional trained model 430, as described above. As another example, the extended trained model may correspond to the model 610, as described above, and may be configured to perform multiple tasks, such as original task 420 and new task 620 and/or 640. Accordingly, the plurality of extended weights may correspond to weights 612, 614, and 617 (or weights 634, 635, and 637), as described above.

In some embodiments, process 800 may further include implementing the preexisting trained model and the extended trained model. For example, the preexisting trained model may be trained to perform a first task and the extended trained model may be trained to perform a second task, as described above. Process 800 may further include performing the first task and the second task using the extended trained model. In some embodiments, at least one processor included in a navigation system of a host vehicle may be programmed to perform the first task and the second task using the extended trained model. For example, the at least one processor may include processing device 112 of vehicle 110, as described above. Accordingly, the host vehicle may include an autonomous or a semi-autonomous vehicle.

The foregoing description has been presented for purposes of illustration. It is not exhaustive and is not limited to the precise forms or embodiments disclosed. Modifications and adaptations will be apparent to those skilled in the art from consideration of the specification and practice of the disclosed embodiments. Additionally, although aspects of the disclosed embodiments are described as being stored in memory, one skilled in the art will appreciate that these aspects can also be stored on other types of computer-readable media, such as secondary storage devices, for example, hard disks or CD ROM, or other forms of RAM or ROM, USB media, DVD, Blu-ray, 4K Ultra HD Blu-ray, or other optical drive media.

Computer programs based on the written description and disclosed methods are within the skill of an experienced developer. The various programs or program modules can be created using any of the techniques known to one skilled in the art or can be designed in connection with existing software. For example, program sections or program modules can be designed in or by means of .Net Framework, .Net Compact Framework (and related languages, such as Visual Basic, C, etc.), Java, C++, Objective-C, HTML, HTML/AJAX combinations, XML, or HTML with included Java applets.

Moreover, while illustrative embodiments have been described herein, the scope of any and all embodiments having equivalent elements, modifications, omissions, combinations (e.g., of aspects across various embodiments), adaptations and/or alterations as would be appreciated by those skilled in the art based on the present disclosure. The limitations in the claims are to be interpreted broadly based on the language employed in the claims and not limited to examples described in the present specification or during the prosecution of the application. The examples are to be construed as non-exclusive. Furthermore, the steps of the disclosed methods may be modified in any manner, including by reordering steps and/or inserting or deleting steps. It is intended, therefore, that the specification and examples be considered as illustrative only, with a true scope and spirit being indicated by the following claims and their full scope of equivalents.

What is claimed is:

1. A method for generating an extended trained model, the method comprising:
obtaining a preexisting trained model, the preexisting trained model including a plurality of preexisting weights, wherein each of the plurality of preexisting weights is associated with a preexisting value;
identifying a subset of the plurality of preexisting weights;
generating a plurality of extended weights based on a training process using duplicates of the subset of the plurality of preexisting weights; and
generating the extended trained model, wherein the extended trained model includes the plurality of preexisting weights and the plurality of extended weights.

2. The method of claim 1, wherein identifying the subset of the plurality of preexisting weights includes selecting the subset of the plurality of preexisting weights based on a comparison of a performance criterion associated with each of the plurality of preexisting weights to a threshold.

3. The method of claim 2, wherein the preexisting trained model is trained to perform a first task, wherein the performance criterion associated with each of the plurality of preexisting weights is determined based on causing the preexisting trained model to perform a second task, and wherein the first task and the second task are different tasks.

4. The method of claim 3, wherein the first task includes identifying a first category of objects represented in one or more images, wherein the second task includes identifying a second category of objects represented in the one or more images, and wherein the first category of objects and the second category of objects are different categories.

5. The method of claim 4, wherein the one or more images are representative of an environment of at least one host vehicle.

6. The method of claim 5, wherein the at least one host vehicle includes an autonomous or a semi-autonomous vehicle.

7. The method of claim 4, wherein the first category of objects includes vehicles and the second category of objects includes traffic signals.

8. The method of claim 4, wherein the first category of objects includes vehicles and the second category of objects includes pedestrians.

9. The method of claim 4, wherein the first category of objects includes vehicles and the second category of objects includes lane markings.

10. The method of claim 4, wherein the first category of objects includes vehicles and the second category of objects includes signs.

11. The method of claim 4, wherein the first category of objects includes a first type of vehicle and the second category of objects includes a second type of vehicle, and wherein the first type of vehicle and the second type of vehicle are different types.

12. The method of claim 11, wherein the first type of vehicle is a sedan and the second type of vehicle is a truck.

13. The method of claim 11, wherein the first type of vehicle is a sedan and the second type of vehicle is a motorcycle.

14. The method of claim 3, wherein the first task includes applying an image segmentation process to one or more images and identifying a first category of objects represented in the one or more images, wherein the second task includes identifying a second category of objects represented in the one or more images, and wherein the first category of objects and the second category of objects are different categories.

15. The method of claim 14, wherein the training process using the duplicates of the subset of the plurality of preexisting weights includes modifying the preexisting value of each of the duplicates of the subset of the plurality of preexisting weights.

16. The method of claim 15, wherein the preexisting trained model is trained to perform a first task, wherein the training process using the duplicates of the subset of the plurality of preexisting weights includes using the duplicates of the subset of the plurality of preexisting weights to perform a second task, and wherein the first task and the second task are different tasks.

17. The method of claim 16, wherein the first task includes identifying a first category of objects represented in one or more images, wherein the second task includes identifying a second category of objects represented in the one or more images, and wherein the first category of objects and the second categories of objects are different categories.

18. The method of claim 17, wherein the one or more images are representative of an environment of at least one host vehicle.

19. The method of claim 18, wherein the at least one host vehicle includes an autonomous or a semi-autonomous vehicle.

20. The method of claim 17, wherein the first category of objects includes vehicles and the second category of objects includes traffic signals.

21. The method of claim 17, wherein the first category of objects includes vehicles and the second category of objects includes pedestrians.

22. The method of claim 17, wherein the first category of objects includes vehicles and the second category of objects includes lane markings.

23. The method of claim 17, wherein the first category of objects includes vehicles and the second category of objects includes signs.

24. The method of claim 17, wherein the first category of objects includes a first type of vehicle and the second category of objects includes a second type of vehicle, and wherein the first type of vehicle and the second type of vehicle are different types.

25. The method of claim 24, wherein the first type of vehicle is a sedan and the second type of vehicle is a truck.

26. The method of claim 24, wherein the first type of vehicle is a sedan and the second type of vehicle is a motorcycle.

27. The method of claim 16, wherein the first task includes applying an image segmentation process to one or more images and identifying a first category of objects represented in the one or more images, wherein the second task includes identifying a second category of objects represented in the one or more images, and wherein the first category of objects and the second category of objects are different categories.

28. The method of claim 16, the method further comprising performing the first task and the second task using the extended trained model.

29. The method of claim 28, wherein at least one processor included in a navigation system of a host vehicle is programmed to perform the first task and the second task using the extended trained model.

30. The method of claim 29, wherein the host vehicle includes an autonomous or a semi-autonomous vehicle.

31. The method of claim 1, wherein the preexisting value of each of the plurality of preexisting weights includes a numerical value.

32. The method of claim 1, wherein the preexisting trained model includes a neural network.

33. A system for generating an extended trained model, the system comprising:
at least one processor programmed to:
obtain a preexisting trained model, the preexisting trained model including a plurality of preexisting weights, wherein each of the plurality of preexisting weights is associated with a preexisting value;
identify a subset of the plurality of preexisting weights;
generate a plurality of extended weights based on a training process using duplicates of the subset of the plurality of preexisting weights; and
generate the extended trained model, wherein the extended trained model includes the plurality of preexisting weights and the plurality of extended weights.

34. The system of claim 33, wherein identifying the subset of the plurality of preexisting weights includes selecting the subset of the plurality of preexisting weights based on a comparison of a performance criterion associated with each of the plurality of preexisting weights to a threshold.

35. The system of claim 34, wherein the preexisting trained model is trained to perform a first task, wherein the performance criterion associated with each of the plurality of preexisting weights is determined based on causing the preexisting trained model to perform a second task, and wherein the first task and the second task are different tasks.

36. The system of claim 35, wherein the first task includes identifying a first category of objects represented in one or more images, wherein the second task includes identifying a second category of objects represented in the one or more images, and wherein the first category of objects and the second category of objects are different categories.

37. The system of claim 35, wherein the first task includes applying an image segmentation process to one or more images and identifying a first category of objects represented in the one or more images, wherein the second task includes identifying a second category of objects represented in the one or more images, and wherein the first category of objects and the second category of objects are different categories.

38. A non-transitory computer-readable medium storing instructions executable by at least one processor to perform a method for generating an extended trained model, the method comprising:
obtaining a preexisting trained model, the preexisting trained model including a plurality of preexisting weights, wherein each of the plurality of preexisting weights is associated with a preexisting value;
identifying a subset of the plurality of preexisting weights;
generating a plurality of extended weights based on a training process using duplicates of the subset of the plurality of preexisting weights; and
generating the extended trained model, wherein the extended trained model includes the plurality of preexisting weights and the plurality of extended weights.

39. The non-transitory computer-readable medium of claim 38, wherein identifying the subset of the plurality of preexisting weights includes selecting the subset of the plurality of preexisting weights based on a comparison of a performance criterion associated with each of the plurality of preexisting weights to a threshold.

40. The non-transitory computer-readable medium of claim 39, wherein the preexisting trained model is trained to perform a first task, wherein the performance criterion associated with each of the plurality of preexisting weights is determined based on causing the preexisting trained model to perform a second task, and wherein the first task and the second task are different tasks.

41. The non-transitory computer-readable medium of claim 40, wherein the first task includes identifying a first category of objects represented in one or more images, wherein the second task includes identifying a second category of objects represented in the one or more images, and wherein the first category of objects and the second category of objects are different categories.

42. The non-transitory computer-readable medium of claim 40, wherein the first task includes applying an image segmentation process to one or more images and identifying a first category of objects represented in the one or more images, wherein the second task includes identifying a second category of objects represented in the one or more images, and wherein the first category of objects and the second category of objects are different categories.
